(19) United States
(12) Patent Application Publication
(10) Pub. No.: US 2014/0100763 A1
(43) Pub. Date: Apr. 10, 2014

(54) ENGINE AUTOMATIC STOP AND RESTART APPARATUS AND METHOD OF AUTOMATICALLY STOPPING AND RESTARTING ENGINE

(71) Applicant: Michitaka FUJIWARA, Hyogo (JP)

(72) Inventor: Michitaka FUJIWARA, Hyogo (JP)

(21) Appl. No.: 13/850,680

(22) Filed: Mar. 26, 2013

(30) Foreign Application Priority Data
Oct. 10, 2012 (JP) 2012-225144

(51) Int. Cl. F02D 17/04

(52) U.S. Cl. CPC F02D 17/04
USPC 701/112

(57) ABSTRACT

The engine automatic stop and restart apparatus includes: a crank-angle sensor for detecting a crank angle of a crankshaft of an engine; a starter for cranking the crankshaft to restart the engine; a fuel injection device for injecting a fuel into the engine; an ignition device for igniting the injected fuel; a reverse-rotation determining section for determining occurrence of reverse rotation of the crankshaft based on the crank angle detected by the crank-angle sensor before the occurrence of the reverse rotation; and an ignition control section for inhibiting energization of the ignition device from being started when the occurrence of the reverse rotation of the crankshaft is determined by the reverse-rotation determining section before the start of the energization of the ignition device.

### BACKGROUND OF THE INVENTION

1. Field of the Invention

The present invention relates to an engine automatic stop and restart apparatus and a method of automatically stopping and restarting an engine, which automatically stop an engine when predetermined engine automatic stop conditions are satisfied, and restart the engine when engine restart conditions are satisfied thereafter.

2. Description of the Related Art

Conventionally, an engine automatic stop and restart apparatus has been developed for the purposes of improvement of fuel efficiency of a vehicle such as an automobile and reduction of an environmental load. When predetermined conditions for stopping an engine (for example, a pedaling operation on a brake pedal at a vehicle speed equal to or smaller than a predetermined speed) are satisfied by an operation performed by a driver, the engine automatic stop and restart apparatus automatically performs fuel-cut to automatically stop the engine.

Thereafter, when predetermined conditions for restarting the engine (for example, an operation for releasing the brake pedal and a pedaling operation on an acceleration pedal) are satisfied by an operation performed by the driver, fuel injection is restarted to automatically restart the engine.

As the engine automatic stop and restart apparatus described above, there is known an apparatus which includes a sensor for detecting whether or not a crankshaft of the engine rotates in a reverse direction. In this apparatus, when the reverse rotation of the crankshaft is detected after the engine is automatically stopped, the fuel injection and ignition are interrupted during the reverse rotation, thereby preventing the reverse rotation of the engine (for example, see Japanese Patent Application Laid-open No. 2006-105143).

However, the conventional technology has the following problems.

In the case of the engine automatic stop and restart apparatus described in Japanese Patent Application Laid-open No. 2006-105143, when the reverse rotation of the crankshaft of the engine is detected, the fuel injection and ignition during the reverse rotation are interrupted. However, an energization state of an ignition device is not taken into consideration.

If the driving of an engine starter is interrupted in a state in which the ignition is interrupted as a result of the detection of reverse rotation of the crankshaft after the energization of the ignition device is started, the crankshaft cannot reach its original ignition angle. Moreover, after the engine is stopped, the energization is required to be cut off so as to prevent the burnout of the ignition device.

Therefore, consequently, a cylinder in a compression stroke is ignited. Therefore, there is a problem in that combustion energy acts in a direction of reverse rotation of the crankshaft to significantly rotate the crankshaft in the reverse direction. Moreover, there is another problem in that a combusted gas remains in the cylinder at the time of the next engine start and it becomes difficult to restart.

### SUMMARY OF THE INVENTION

The present invention has been made to solve the problems described above, and therefore has an object to provide an engine automatic stop and restart apparatus and a method of automatically stopping and restarting an engine, which are capable of preventing the occurrence of ignition which accelerates the reverse rotation of a crankshaft and realizing good startability.

According to an exemplary embodiment of the present invention, there is provided an engine automatic stop and restart apparatus for stopping fuel injection to an engine based on satisfaction of an engine automatic stop condition to automatically stop the engine and then restarting the engine based on satisfaction of an engine restart condition, the engine automatic stop and restart apparatus including: a crank-angle sensor for detecting a crank angle of a crankshaft of the engine; a starter for cranking the crankshaft to restart the engine; a fuel injection device for injecting a fuel into the engine; an ignition device for igniting the injected fuel; a reverse-rotation determining section for determining occurrence of reverse rotation of the crankshaft based on the crank angle detected by the crank-angle sensor before the occurrence of the reverse rotation; and an ignition control section for inhibiting energization of the ignition device from being started when the occurrence of the reverse rotation of the crankshaft is determined by the reverse-rotation determining section before the start of the energization of the ignition device.

Further, according to another exemplary embodiment of the present invention, there is provided a method of automatically stopping and restarting an engine, executed by an engine automatic stop and restart apparatus for stopping fuel injection to an engine based on satisfaction of an engine automatic stop condition to automatically stop the engine and then restarting the engine based on satisfaction of an engine restart condition, the method including: a reverse-rotation determination step of determining occurrence of reverse rotation of a crankshaft of the engine based on a crank shaft angle of the crankshaft before the occurrence of the reverse rotation; and an ignition control step of inhibiting start of energization of the ignition device when the occurrence of the reverse rotation of the crankshaft is determined in the reverse-rotation determination step before the start of the energization of the ignition device for igniting a fuel injected into the engine.

In the engine automatic stop and restart apparatus and the method of automatically stopping and restarting the engine according to the present invention, when the reverse-rotation determining section for determining whether or not the reverse rotation of the crankshaft occurs based on the crank angle detected by the crank-angle sensor before the occurrence of the reverse rotation determines the occurrence of the reverse rotation of the crankshaft before the start of energization of the ignition device, the ignition control section inhibits the energization of the ignition device from being started.

Therefore, the occurrence of ignition which accelerates the reverse rotation of the crankshaft can be prevented, and good startability can be realized.

### BRIEF DESCRIPTION OF THE DRAWINGS

In the accompanying drawings:

FIG. 1 is a block configuration diagram illustrating an engine automatic stop and restart apparatus according to a first embodiment of the present invention;

FIG. 2 is a block configuration diagram specifically illustrating an engine control unit of the engine automatic stop and restart apparatus according to the first embodiment of the present invention;

FIG. 3 is a configuration diagram illustrating a crank-angle sensor of the engine automatic stop and restart apparatus according to the first embodiment of the present invention; FIG. 4 is an explanatory diagram illustrating signal characteristics in the crank-angle sensor of the engine automatic stop and restart apparatus according to the first embodiment of the present invention;

FIG. 5 is a flowchart illustrating an engine automatic stop and restart control routine executed by an engine automatic stop and restart control section of the engine automatic stop and restart apparatus according to the first embodiment of the present invention;

FIG. 6 is a timing chart illustrating fuel injection at the time of engine restart by the engine automatic stop and restart apparatus according to the first embodiment of the present invention;

FIG. 7 is a flowchart illustrating an energization inhibition determination routine executed by an energization inhibition determining section of the engine automatic stop and restart apparatus according to the first embodiment of the present invention;

FIG. 8 is an explanatory diagram illustrating a threshold map for determining the occurrence of reverse rotation of an engine in the engine automatic stop and restart apparatus according to the first embodiment of the present invention;

FIG. 9 is a flowchart illustrating an energization inhibition cancel determination routine executed by an energization inhibition cancel determining section of the engine automatic stop and restart apparatus according to the first embodiment of the present invention;

FIG. 10 is a flowchart illustrating an automatic stop and restart time ignition control routine executed by an automatic stop and restart time ignition control section of the engine automatic stop and restart apparatus according to the first embodiment of the present invention;

FIG. 11 is a timing chart illustrating an operation of a conventional engine automatic stop and restart apparatus;

FIG. 12 is a timing chart illustrating an operation of the engine relating to automatic stop and restart by the engine automatic stop and restart apparatus according to the first embodiment of the present invention; and

FIG. 13 is another timing chart illustrating the operation of the engine relating to automatic stop and restart by the engine automatic stop and restart apparatus according to the first embodiment of the present invention.

### DETAILED DESCRIPTION OF THE PREFERRED EMBODIMENT

In the following, an engine automatic stop and restart apparatus and a method of automatically stopping and restarting an engine according to a preferred embodiment of the present invention are described referring to the accompanying drawings. In the drawings, the same or corresponding parts are denoted by the same reference symbols for description.

### First Embodiment

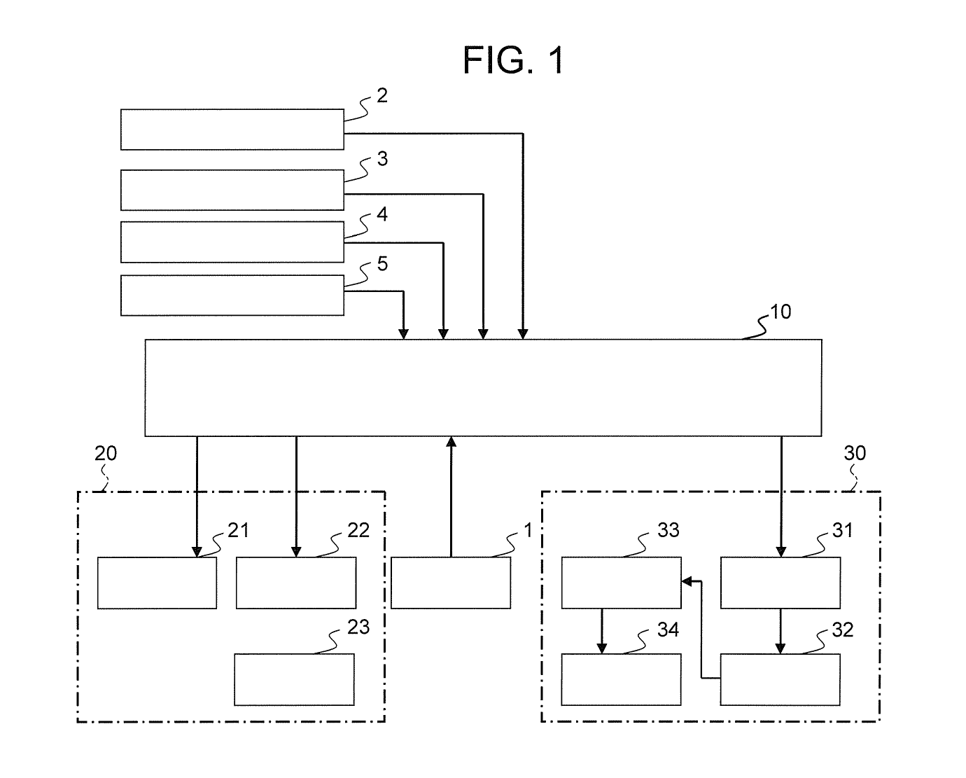

FIG. 1 is a block configuration diagram illustrating an engine automatic stop and restart apparatus according to a first embodiment of the present invention. In FIG. 1, the engine automatic stop and restart apparatus includes an engine control unit (ECU) 10, an engine 20, and a starter 30.

A crank-angle sensor 1, a vehicle-speed sensor 2, an accelerator opening-degree sensor 3, a brake unit 4, an ignition switch 5, the engine 20, and the starter 30 are connected to the engine control unit 10. The engine 20 includes a fuel injection device 21, an ignition device 22, and a ring gear 23. The starter 30 includes a solenoid 31, a plunger 32, a starter motor 33, and a pinion gear 34.

The crank-angle sensor 1 detects a crank angle of a crankshaft (not shown) of the engine 20 to output a crank-angle signal. The vehicle-speed sensor 2 detects a speed of a vehicle to output a vehicle-speed signal. The accelerator opening-degree sensor 3 detects an opening degree of an accelerator pedal to output an accelerator opening-degree signal. The brake unit 4 outputs a brake signal indicating an operating state of a brake pedal. The ignition switch 5 outputs an ignition signal in accordance with an ON/OFF state of an ignition.

The engine control unit 10 controls the driving of the fuel injection device 21 and the ignition device 22 of the engine 20 based on the crank-angle signal, the vehicle-speed signal, the accelerator opening-degree signal, the brake signal, and the ignition signal, and determines whether or not restart conditions are satisfied. When the restart conditions are satisfied, the engine control unit 10 connects a power source (not shown) and the starter 30 to control the engine start by the starter 30.

The fuel injection device 21 of the engine 20 injects a fuel to the engine 20 based on an injection command from the engine control unit 10, whereas the ignition device 22 ignites the injected fuel based on an ignition command from the engine control unit 10.

The solenoid 31 of the starter 30 moves the plunger 32 in a direction of a rotary shaft by energization. The plunger 32 pushes out the pinion gear 34 in the direction of the rotary shaft so that the pinion gear 34 comes into meshing engagement with the ring gear 23 provided to the crankshaft of the engine 20. The starter motor 33 rotates by energization. The pinion gear 34 is provided to a rotary shaft of the starter motor 33.

In the starter 30, the solenoid 31 is first energized based on a start command from the engine control unit 10 so that the plunger 32 is pulled in the direction of the rotary shaft. Subsequently, by pulling the plunger 32, the pinion gear 34 is pushed out in the direction of the rotary shaft to come into contact with and meshing engagement with the ring gear 23. Thereafter, a contact is closed by the movement of the plunger 32 to energize the starter motor 33. As a result, the ring gear 23, which is held in meshing engagement with the pinion gear 34, is rotated.

Note that, the engine control unit 10 includes various I/F circuits (not shown) and a microcomputer (not shown). In addition, the microcomputer includes: an A/D converter (not shown) which converts analog signals from the above-mentioned various sensors into digital signals; a CPU (not shown) which executes various control programs such as an engine automatic stop and restart control program; a ROM (not shown) which stores the engine automatic stop and restart control program, various control programs, control constants, various tables, and the like; and a RAM (not shown) which stores variables and the like when the various control programs are executed.

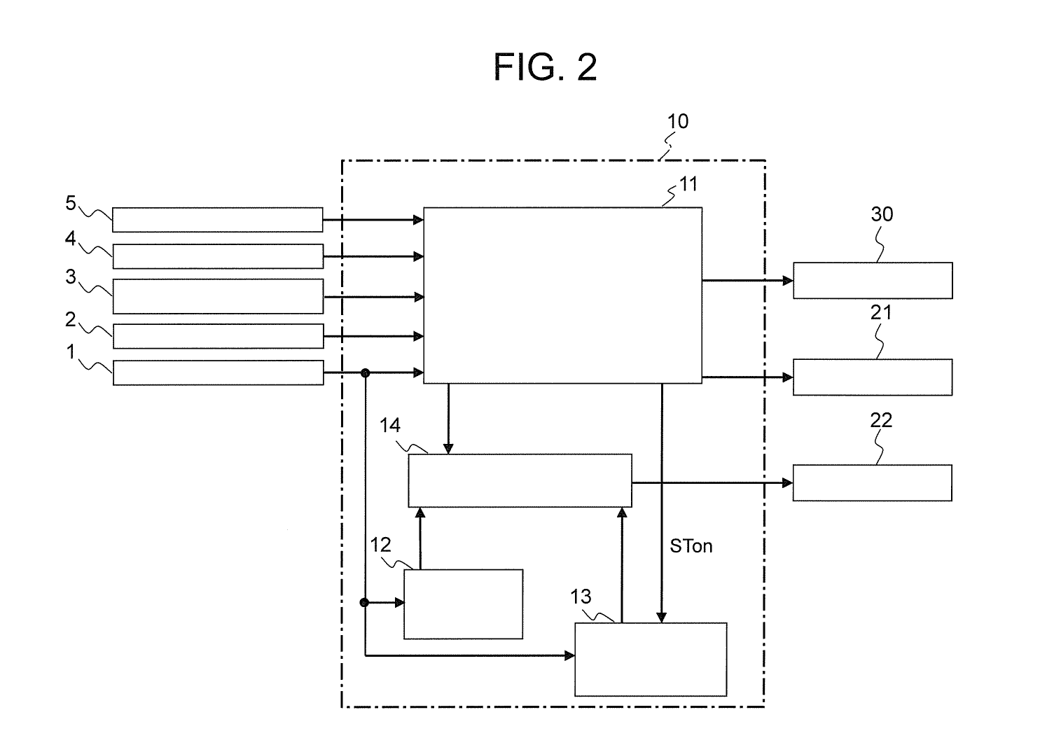

FIG. 2 is a block configuration diagram specifically illustrating the engine control unit 10 of the engine automatic stop and restart apparatus according to the first embodiment of the present invention. In FIG. 2, the engine control unit 10 includes an engine automatic stop and restart control section 11, an energization inhibition determining section (reverse-rotation determining section) 12, an energization inhibition cancel determining section 13, and an ignition control section 14 at the time of automatic stop and restart (ignition control section) (hereinafter referred to as “automatic stop and restart time ignition control section 14”).

When the engine automatic stop and restart control section 11 first determines, based on the vehicle-speed signal output from the vehicle-speed sensor 2, the accelerator opening-degree signal output from the accelerator opening-degree sensor 3, and the brake signal output from the brake unit 4, that automatic stop conditions of the engine 20 are satisfied, the engine automatic stop and restart control section 11 stops the fuel injection by the fuel injection device 21.

When the engine automatic stop and restart control section 11 determines, based on the accelerator opening-degree signal output from the accelerator opening-degree sensor 3 and the brake signal output from the brake unit 4, that restart conditions of the engine 20 are satisfied after the engine 20 is automatically stopped, the engine automatic stop and restart control section 11 restarts the fuel injection by the fuel injection device 21 to energize the starter 30, thereby restarting the engine 20.

Next, the energization inhibition determining section 12 determines, based on the crank-angle signal output from the crank-angle sensor 1 and an engine rpm computed by using the crank-angle signal, whether or not to inhibit the energization of the ignition device 22.

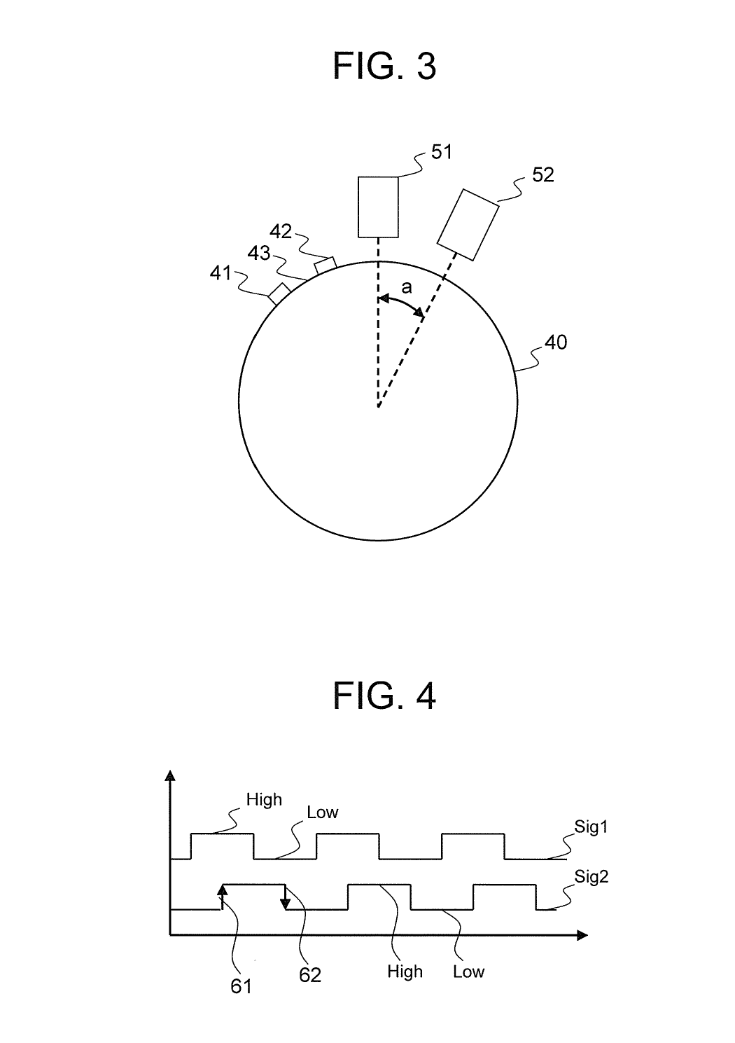

Here, referring to FIGS. 3 and 4, the crank-angle sensor 1 is described. FIG. 3 is a configuration diagram illustrating the crank-angle sensor 1 of the engine automatic stop and restart apparatus according to the first embodiment of the present invention. FIG. 4 is an explanatory diagram illustrating signal characteristics in the crank-angle sensor 1 of the engine automatic stop and restart apparatus according to the first embodiment of the present invention.

In FIG. 3, the crank-angle sensor 1 includes a rotor 40, a first sensor 51, and a second sensor 52. The rotor 40 is connected to the crankshaft and includes teeth 41 and 42 provided equiangularly on an outer circumference of the rotor 40 and gaps 43 therebetween. Each interval between the teeth is, for example, 10 degrees.

The first sensor 51 and the second sensor 52 are arranged so as to be shifted by “a” degrees from each other with respect to the rotor 4. In the crank-angle sensor 1 as described above, a direction of rotation of the crankshaft is determined based on the temporal relationship of outputs from the first sensor 51 and the second sensor 52.

In FIG. 4, a signal characteristic of the first sensor 51 is indicated by Sig1, whereas a signal characteristic of the second sensor 52 is indicated by Sig2. The rotor 40 rotates in synchronization with the rotation of the crankshaft. Then, by the passage of the teeth 41 and 42 and the gaps 43 below the first sensor 51 and the second sensor 52, the rectangular signals Sig1 and Sig2 are generated as electric signals as illustrated in FIG. 4.

Here, each of the signals Sig1 and Sig2 is in High (H) state or Low (L) state. A change from Low to High (L to H) is indicated as a rising edge 61, whereas a change from High to Low (H to L) is indicated as a falling edge 62. Note that, the direction of rotation of the crankshaft is determined by using the following relationships.

Sig1: H to L and Sig2: L, then reverse rotation

Sig1: L to H and Sig2: H, then reverse rotation

Sig1: H and Sig2: H to L, then reverse rotation

Sig1: L and Sig2: L to H, then reverse rotation

Sig1: H to L and Sig2: H, then forward rotation

Sig1: L to H and Sig2: L, then forward rotation

Sig1: H and Sig2: L to H, then forward rotation

Sig1: L and Sig2: H to L, then forward rotation

In the above-mentioned relationships, by the combination of the rising edge or the falling edge of one of the signals and the level of another of the signals, the direction of rotation of the crankshaft can be determined. For example, when the signal Sig1 has the falling edge “H to L” and the level of the signal Sig2 is “H”, the direction of rotation of the crankshaft is determined as forward. Note that, the configuration described above is merely an example, and any configuration may be used as long as the direction of rotation of the engine can be determined.

Returning to FIG. 2, subsequently, the energization inhibition cancel determining section 13 determines, based on information of energization time of the starter 30, the crank-angle signal output from the crank-angle sensor 1, and the engine rpm computed by using the crank-angle signal, whether or not to cancel the inhibition of energization of the ignition device 22.

Next, the automatic stop and restart time ignition control section 14 controls the ignition device 22 at the time of automatic stop of the engine and the time of restart of the engine in accordance with processing performed in the engine automatic stop and restart control section 11, the energization inhibition determining section 12, and the energization inhibition cancel determining section 13.

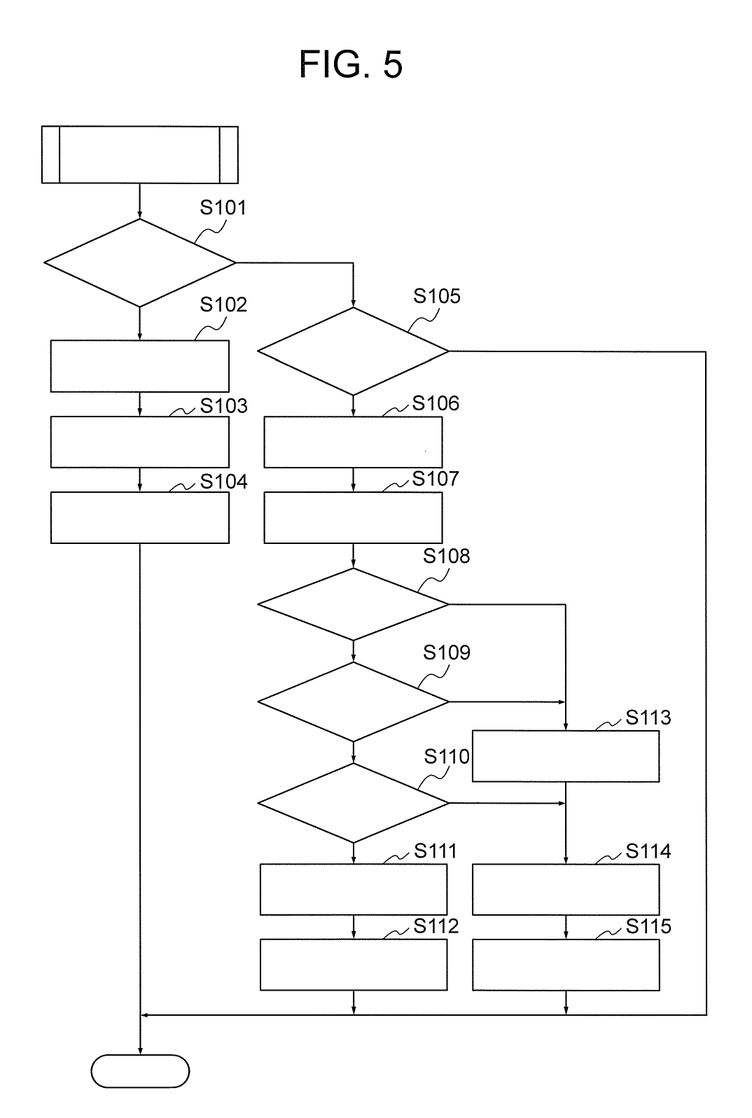

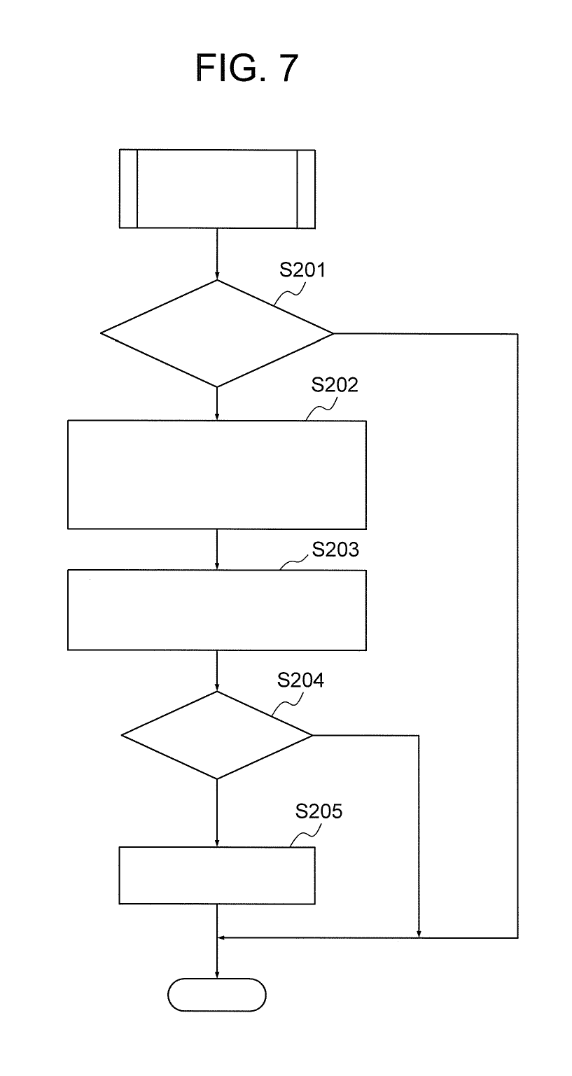

In the following, referring to FIGS. 5 to 10, an operation of the engine automatic stop and restart apparatus according to the first embodiment of the present invention is described. For processing illustrated in FIGS. 5 to 10, for example, processing illustrated in FIG. 5 is executed in constant cycles of 5 ms, and processing in FIGS. 7, 9, and 10 is executed for each input of the signal output from the crank-angle sensor 1 (for example, at every 10 degrees).

In FIGS. 5, 7, 9, and 10, processing in Steps S101 to S115, Steps S201 to S105, Steps S301 to S307, and Steps S401 to S407 is executed by the engine automatic stop and restart control program stored in the ROM of the engine control unit 10.

The engine control unit 10 starts its operation when the ignition switch 5 is turned ON and the power is supplied from a battery installed on the vehicle. The CPU including the microcomputer provided in the engine control unit 10 executes the engine automatic stop and restart control program stored in the ROM as follows.

First, referring to the flowchart of FIG. 5, the engine automatic stop and restart control section 11 illustrated in FIG. 2 is described in detail. FIG. 5 is a flowchart illustrating an engine automatic stop and restart control routine executed by the engine automatic stop and restart control section 11 of the engine automatic stop and restart apparatus according to the first embodiment of the present invention.

First, in FIG. 5, the engine automatic stop and restart control section 11 determines whether or not the automatic stop conditions are satisfied (Step S101). Here, the automatic stop conditions are determined to be satisfied, for example, when the vehicle speed is 10 km/h or lower and a driver is pedaling the brake pedal. Note that, the vehicle speed is based on the vehicle-speed signal output from the vehicle-speed sensor 2, and the operating state in which the brake pedal is pressed down is based on the brake signal (ON state) from the brake unit 4.

In Step S101, when it is determined that the automatic stop conditions are satisfied (specifically, Yes), the engine automatic stop and restart control section 11 sets an automatic stop request flag F1 to “1” (Step S102), sets an automatic stop-state flag F2 to “1” (Step S103), stops the fuel injection to the engine 20 by the fuel injection device 21 (Step S104), and terminates the processing illustrated in FIG. 5.

On the other hand, when it is determined in Step S101 that the automatic stop conditions are not satisfied (specifically, No), the engine automatic stop and restart control section 11 then determines whether or not the restart conditions are satisfied (Step S105). The satisfaction of the restart conditions is determined based on, for example, an operating state in which the brake pedal is released and the accelerator pedal is being pressed down by a driver.

Note that, the operating state in which the brake pedal is released is determined based on the brake signal (OFF state) from the brake unit 4. The operating state in which the accelerator pedal is being pressed down is determined based on the accelerator opening-degree signal output from the accelerator opening-degree sensor 3.

In Step S105, when it is determined that the restart conditions are satisfied (specifically, Yes), the engine automatic stop and restart control section 11 clears the automatic stop request flag F1 to “0” (Step S106), and restarts the fuel injection to the engine 20 (a start fuel is injected) by the fuel injection device 21 (Step S107).

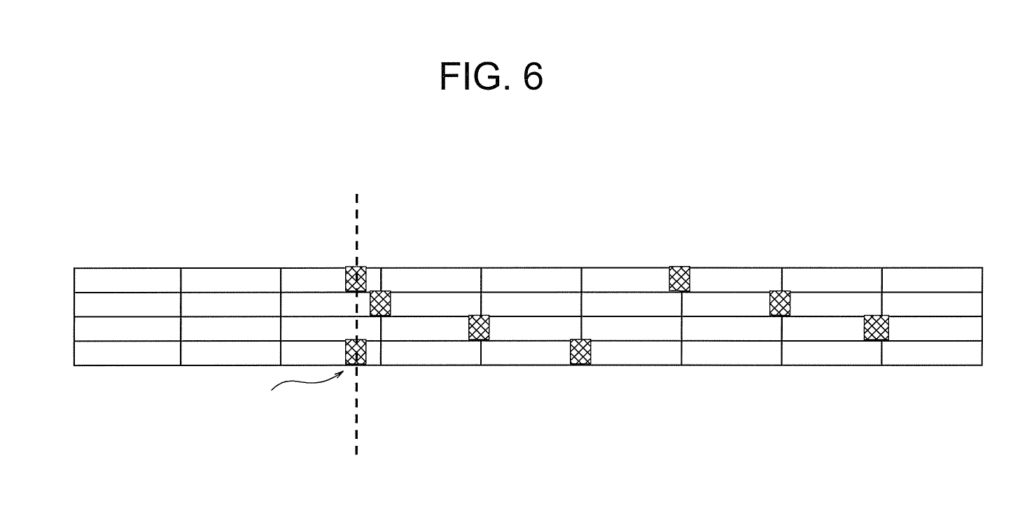

Here, referring to FIG. 6, the fuel injection at the time of restart of the engine 20 is described. FIG. 6 is a timing chart illustrating the fuel injection at the time of engine restart by the engine automatic stop and restart apparatus according to the first embodiment of the present invention.

FIG. 6 illustrates the case where the engine 20 has four cylinders. A hatched area in FIG. 6 indicates fuel injection timing. During the automatic stop, the fuel injection is interrupted. As soon as the restart operation is started, the fuel injection is restarted in a plurality of predetermined cylinders (for example, a cylinder No. 1 in an exhaust stroke and a cylinder No. 2 in an intake stroke). Thereafter, the fuel injection is restarted at predetermined timing (each time when the crank angle of the cylinder in a combustion stroke is at 5 degrees BTDC).

Returning to FIG. 5, subsequently, the engine automatic stop and restart control section 11 determines whether or not the ignition signal output from the ignition switch 5 is ON (Step S108).

When it is determined in Step S108 that the ignition signal is ON (specifically, Yes), the engine automatic stop and restart control section 11 determines, based on the engine rpm, whether or not the restart of the engine 20 is not completed (Step S109).

In Step S109, when it is determined that the engine rpm is smaller than a predetermined value and therefore the restart of the engine 20 is not completed (specifically, Yes), the engine automatic stop and restart control section 11 then determines whether or not an absolute value of the engine rpm Ne is smaller than an rpm threshold value Ne_st (Step S110). Here, the predetermined value for determining the start of the engine is, for example, 600 rpm.

In Step S110, when it is determined that the absolute value of the engine rpm. Ne is smaller than the rpm threshold value Ne_st (specifically, Yes), the engine automatic stop and restart control section 11 turns ON to energize the starter 30 (Step S111), starts time measurement of starter energization time STon (Step S112), and terminates the processing illustrated in FIG. 5. Here, the engine rpm threshold value Ne_st is, for example, 50 rpm.

When the starter 30 is energized, the solenoid 31 is first energized to pull the plunger 32, to thereby push out the pinion gear 34 in the direction of the rotary shaft. As a result, the pinion gear 34 comes into contact with and meshing engagement with the ring gear 23 provided to the crankshaft of the engine 20. Subsequently, by the movement of the plunger 32, the contact is closed to energize the starter motor 33. As a result, the ring gear 23, which is in meshing engagement with the pinion gear 34, is rotated.

On the other hand, when the restart is interrupted and it is determined in Step S108 that the ignition signal is OFF (specifically, No) and it is determined in Step S109 that the engine rpm is equal to or larger than the predetermined value and the restart is completed by the combustion in the engine 20 (Specifically, No), the engine automatic stop and restart control section 11 clears the automatic stop-state flag F2 to “0” (Step S113).

Subsequently, the engine automatic stop and restart control section 11 turns OFF the energization of the starter 30 (Step S114), clears the time measurement of the starter energization time STon (Step S115), and terminates the processing illustrated in FIG. 5.

On the other hand, when it is determined in Step S110 that the absolute value of the engine rpm Ne is equal to or larger than the rpm threshold value Ne_st (specifically, No), the processing performed by the engine automatic stop and restart control section 11 proceeds to Step S114.

On the other hand, when it is determined in Step S105 that the restart conditions are not satisfied (specifically, No), the engine automatic stop/start control section 11 directly terminates the processing illustrated in FIG. 5.

Next, referring to the flowchart of FIG. 7, the energization inhibition determining section 12 illustrated in FIG. 2 is described in detail. FIG. 7 is a flowchart illustrating an energization inhibition determination routine executed by the energization inhibition determining section 12 of the engine automatic stop and restart apparatus according to the first embodiment of the present invention.

In FIG. 7, first, the energization inhibition determining section 12 determines, based on the crank-angle signal output from the crank-angle sensor 1, whether or not the crankshaft of the engine 20 is at an angle at which the energization of the ignition device 22 is to be started (Step S201).

In Step S201, when it is determined that the crankshaft of the engine 20 is at the crank angle at which the energization of the ignition device 22 is to be started (hereinafter referred to as “energization start crank angle”) (specifically, Yes), the energization inhibition determining section 12 calculates an engine rpm change amount Ne_dlt based on the engine rpm computed by using the crank-angle signal output from the crank-angle sensor 1 (Step S202).

Specifically, the energization inhibition determining section 12 calculates the engine rpm change amount Ne_dlt by using the following Expression (1) from an engine rpm Ne_ign(n) at the energization start crank angle and an engine rpm Ne_ign(n−1) at the previous energization start crack angle. Note that, in Expression (1), n is current timing, and n−1 is timing at the previous energization start crank angle.

Ne_dlt=Ne_ign (n)−-Ne_ign (n−1) (1)

Subsequently, the energization inhibition determining section 12 calculates an engine reverse-rotation occurrence determining threshold value Ne_rev by using the following Expression (2) from the engine rpm change amount Ne_dlt calculated in Step S202 and an engine reverse-rotation occurrence determining threshold map M_rev (Step S203).

Ne_rev=M_rev (Ne_dlt) (2)

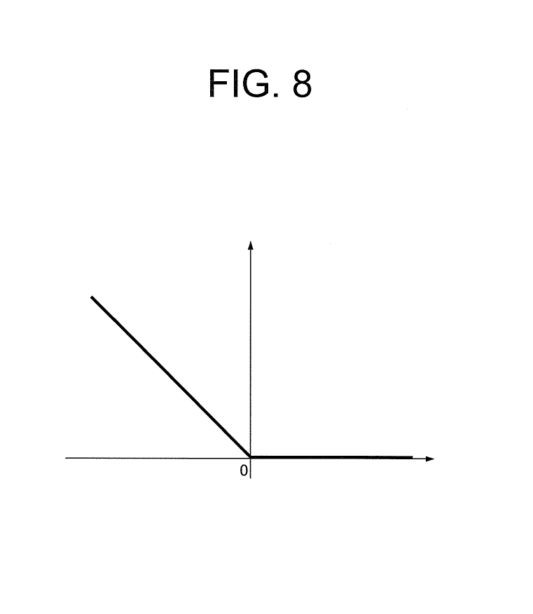

The engine reverse-rotation occurrence determining threshold map M_rev is a threshold map for determining the occurrence of the reverse rotation of the engine 20, for example, a threshold map shown in FIG. 8, and is preset by a vehicle test with a real vehicle.

Next, the energization inhibition determining section 12 determines, based on the engine rpm computed by using the crank-angle signal output from the crank-angle sensor 1, whether or not the engine rpm Ne_ign (n) at the energization start crank angle is smaller than the engine reverse-rotation occurrence determining threshold value Ne_rev (Step S204).

In Step S204, when it is determined that the engine rpm Ne_ign (n) at the energization start crank angle is smaller than the engine reverse-rotation occurrence determining threshold value Ne_rev (specifically, Yes), the energization inhibition determining section 12 determines that the reverse rotation of the engine 20 may occur during the energization of the ignition device 22, sets an energization inhibition determination flag F3 to “1” (Step S205), and terminates the processing illustrated in FIG. 7.

On the other hand, when it is determined in Step S201 that the crankshaft of the engine 20 is not at the angle at which the energization of the ignition device 22 is to be started (specifically, No) and it is determined in Step S204 that the engine rpm Ne_ign(n) at the energization start crank angle is equal to or larger than the engine reverse-rotation occurrence determining threshold value Ne_rev (specifically, No), the energization inhibition determining section 12 directly terminates the processing illustrated in FIG. 7.

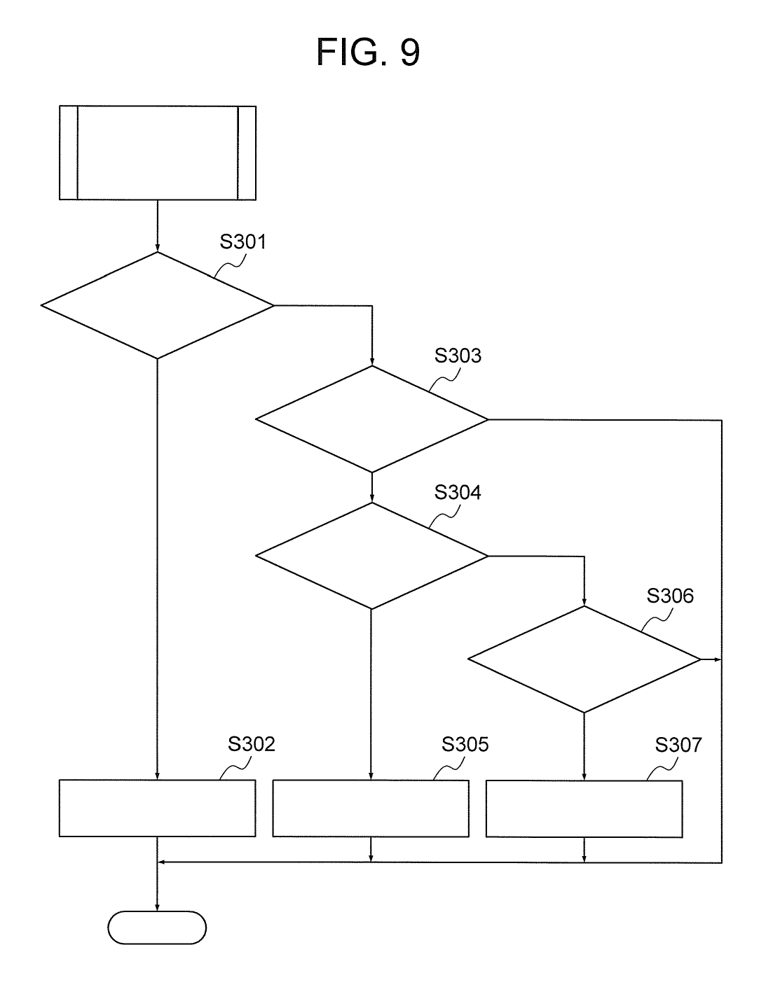

Next, referring to the flowchart of FIG. 9, the energization inhibition cancel determining section 13 illustrated in FIG. 2 is described in detail. FIG. 9 is a flowchart illustrating an energization inhibition cancel determination routine executed by the energization inhibition cancel determining section 13 of the engine automatic stop and restart apparatus according to the first embodiment of the present invention.

In FIG. 9, first, the energization inhibition cancel determining section 13 determines, based on the crank-angle signal output from the crank-angle sensor 1, whether or not the crank angle is equal to or larger than a predetermined value (Step S301).

In Step S301, when it is determined that the crank angle is equal to or larger than the predetermined value (specifically, Yes), in other words, when it is determined that the crank angle passes through TDC to reach the angle at which the reverse rotation does not occur, the energization inhibition cancel determining section 13 clears the energization inhibition determination flag F3 to “0” (Step S302) and terminates the processing illustrated in FIG. 9.

On the other hand, when it is determined in Step S301 that the crank angle is smaller than the predetermined value (specifically, No), the energization inhibition cancel determining section 13 determines whether or not the energization of the starter 30 is ON (Step S303).

In Step S303, when it is determined that the energization of the starter 30 is ON (specifically, Yes), the energization inhibition determining section 13 determines whether or not the energization time STon of the starter 30 is equal to or longer than predetermined time (Step S304).

In Step S304, when it is determined that the energization time STon of the starter 30 is equal to or longer than the predetermined time (specifically, Yes), in other words, when it is determined that the pinion gear 34 has come into meshing engagement with the ring gear 23, the energization inhibition cancel determining section 13 clears the energization inhibition determination flag F3 to “0” (Step S305) and terminates the processing illustrated in FIG. 9. Here, a determination threshold value of the starter energization time STon is time which allows the engine to be reliably driven after the start of the energization of the starter 30, and is, for example, 50 ms.

On the other hand, when it is determined in Step S304 that the energization time STon of the starter 30 is shorter than the predetermined time (specifically, No), the energization inhibition cancel determining section 13 determines whether or not the crank angle has been detected as a forward-rotation signal (Step S306).

In Step S306, when it is detected that the crank angle is the forward-rotation signal (specifically, Yes), in other words, when it is determined that the engine 20 rotates in the direction of forward rotation by the starter 30, the energization inhibition cancel determining section 13 clears the energization inhibition determination flag F3 to “0” (Step S307) and terminates the processing illustrated in FIG. 9.

On the other hand, when it is determined in Step S303 that the energization of the starter 30 is not ON (specifically, No) and it is determined in Step S306 that the crank angle is not detected as the forward-rotation signal (specifically, No), the energization inhibition cancel determining section 13 directly terminates the processing illustrated in FIG. 9.

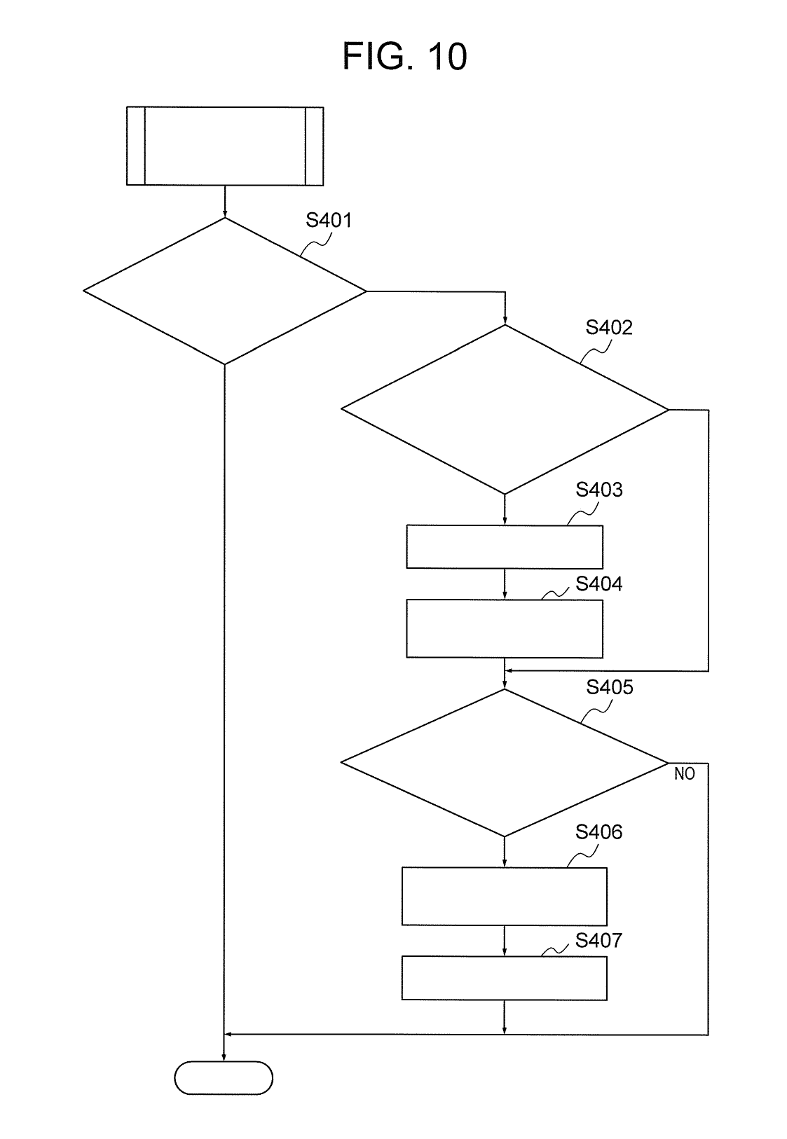

Finally, referring to the flowchart of FIG. 10, the automatic stop and restart time ignition control section 14 illustrated in FIG. 2 is described in detail. FIG. 10 is a flowchart illustrating an automatic stop and restart time ignition control routine executed by the automatic stop and restart time ignition control section 14 of the engine automatic stop and restart apparatus according to the first embodiment of the present invention.

In FIG. 10, the automatic stop and restart time ignition control section 14 first determines whether or not the automatic stop request flag F1 is “1” and the ignition of the injected fuel is completed (Step S401). Here, whether or not the ignition of the injected fuel is completed is determined in the following manner. Specifically, when the fuel ignition is stopped in Step S104 of FIG. 5, the cylinder into which the fuel has already been injected is stored. Then, the ignition of the injected fuel is determined whether or not the ignition is performed in the cylinder into which the fuel has been injected.

In Step S401, when it is determined that the automatic stop request flag F1 is “1” and the ignition of the injected fuel is completed (specifically, Yes), the automatic stop and restart time ignition control section 14 directly terminates the processing illustrated in FIG. 10 without performing ignition processing.

On the other hand, when it is determined in Step S401 that the automatic stop request flag F1 is “0” or the ignition of the injected fuel is not completed (specifically, No), the automatic stop and restart time ignition control section 14 determines whether or not the energization inhibition determination flag F3 is “0” and whether or not the crank angle is equal to or larger than the angle at which the energization of the ignition device 22 is started (Step S402). Here, the angle of starting the energization of the ignition device 22 is, for example, 75 degrees BTDC.

In Step S402, when it is determined that the energization inhibition determination flag F3 is “0” and the crank angle is equal to or larger than the angle of starting the energization of the ignition device 22 (specifically, Yes), the automatic stop and restart time ignition control section 14 starts the energization of the ignition device 22 for the cylinder in the compression stroke in preparation for the ignition (Step S403) and starts the measurement of the energization time of the ignition device (Step S404).

Subsequently, the automatic stop and restart time ignition control section 14 determines whether or not the crank angle is equal to or smaller than an energization interruption crank angle and whether or not the energization time of the ignition device 22 is equal to or larger than a predetermined value (Step S405). Here, the predetermined value for determining the energization time of the ignition device 22 is time obtained from a battery voltage or the like, at which the ignition reliably occurs by the interruption of energization.

In Step S405, when it is determined that the crank angle is equal to or larger than the energization interruption crank angle and the energization time of the ignition device 22 is equal to or larger than the predetermined value (specifically, Yes), the automatic stop and restart time ignition control section 14 determines that the ignition is possible in this state, interrupts the energization of the ignition device 22, for which the energization has been started, to perform the ignition (Step S406), clears the measurement of the energization time of the ignition device 22 (Step S407), and terminates the processing illustrated in FIG. 10.

On the other hand, when it is determined in Step S402 that the energization inhibition determination flag F3 is “1” or the crank angle is smaller than the angle of starting the energization of the ignition device 22 (specifically, No), the processing performed by the automatic stop and restart time ignition control section 14 proceeds to Step S405.

On the other hand, when it is determined in Step S405 that the crank angle is smaller than the energization interruption crank angle or the energization time of the ignition device 22 is smaller than the predetermined value (specifically, No), the automatic stop and restart time ignition control section 14 determines that the ignition is impossible in this state and directly terminates the processing illustrated in FIG. 10.

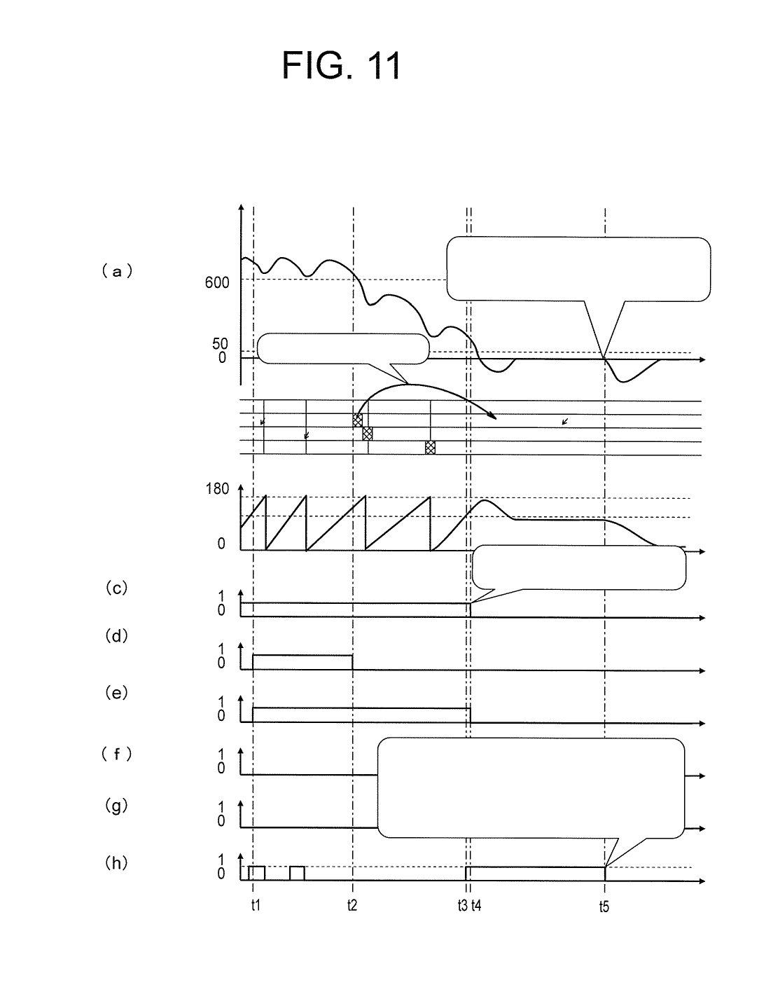

In the following, referring to timing charts of FIGS. 11 to 13, the operation of the engine automatic stop and restart apparatus according to the first embodiment of the present invention is described in comparison with an operation of a conventional engine automatic stop and restart apparatus.

FIG. 11 is a timing chart illustrating the operation of the conventional engine automatic stop and restart apparatus. Here, the following case is illustrated. In the conventional apparatus disclosed in Japanese Patent Application Laid-open No. 2006-105143 described above, the engine automatic stop is implemented in a vehicle running state. When the restart conditions are satisfied based on the operation performed by the driver while the engine is rotating by inertia, the fuel injection is restarted. Immediately after the energization of the ignition device is started in preparation for the ignition of the injected fuel, the ignition switch is turned OFF to interrupt the restart.

In FIG. 11, the part (a) shows the engine rpm Ne, and the part (b) shows a temporal transition of the crank angle, which repeats for each 180 degrees when the crank angle of the engine detected by the crank-angle sensor 1 for the four-cylinder engine at the TDC is set as 0 degrees.

In FIG. 11, the part (c) shows a state of the ignition switch 5, which is set to “1” when the ignition switch 5 is ON and is cleared to “0” when the ignition switch 5 is OFF. The part (d) shows a state of the automatic stop request flag F1, which is set to “1” when the automatic stop conditions are satisfied and is cleared to “0” when the restart conditions are satisfied. The part (e) shows a state of the automatic stop-state flag F2, which is set to “1” when the engine 20 is in an automatically stopped state and is cleared to “0” when the start of the engine 20 is completed.

Further, in FIG. 11, the part (f) shows the energization state of the starter 30 and also a temporal transition of the energization state of the solenoid 31. The part (g) shows a temporal transition of the energization state of the starter motor 33. Note that, the energization state of the starter motor 33 is experimentally obtained by using the sensor. The part (h) shows a temporal transition of the energization state of the ignition device 22.

In the case of the conventional apparatus described in Japanese Patent Application Laid-open No. 2006-105143, when the reverse rotation of the crankshaft of the engine 20 is detected by the crank-angle sensor 1 which can detect whether or not the crankshaft of the engine 20 is rotating in the reverse direction, as illustrated in FIG. 11, the ignition is suppressed during the reverse rotation.

However, when the engine 20 is stopped as a result of occurrence of the reverse rotation after the energization is started by turning OFF the ignition switch 5, the energization of the ignition device 22 is continued for the cylinder to which the fuel is injected, and which is in the compression stroke (time t4). Thereafter, when the energization of the ignition device 22 is interrupted based on conditions such as time for the purpose of prevention of burnout of the ignition device 22 (time t5), the injected fuel is ignited. As a result, there is a problem in that the combustion energy acts in the direction of reverse rotation of the crankshaft to accelerate the reverse rotation.

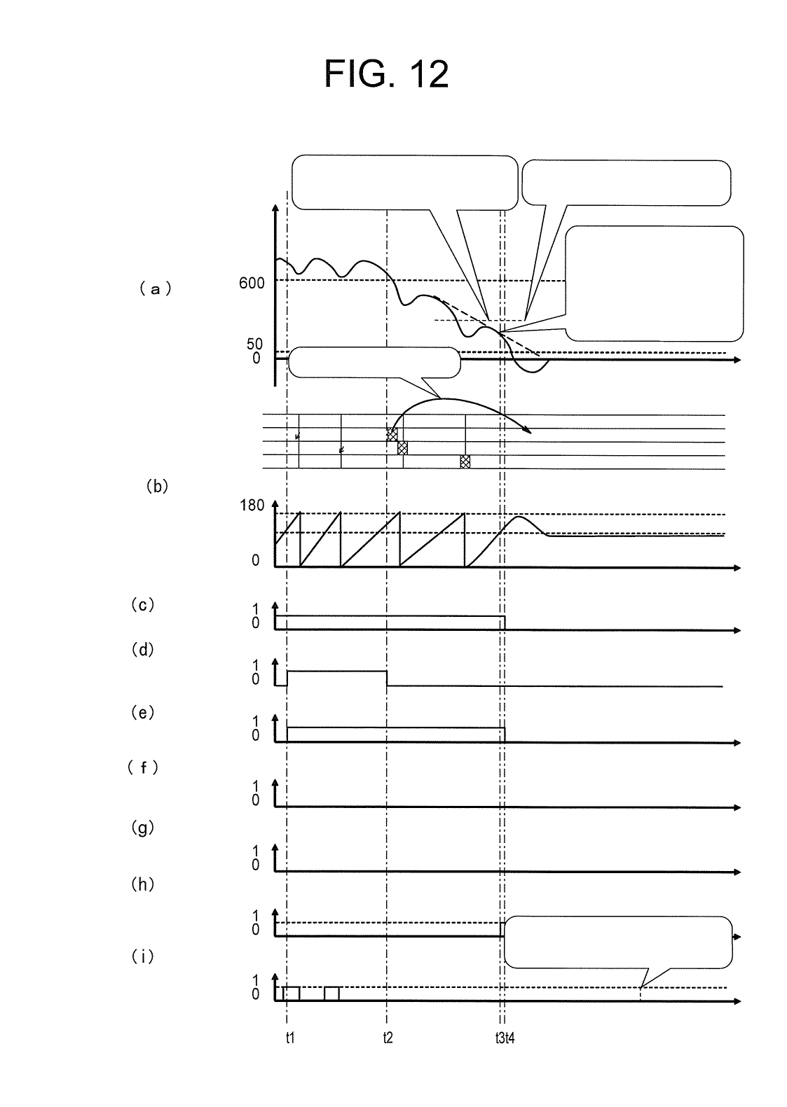

FIG. 12 is a timing chart illustrating the operation of the engine 20 relating to the automatic stop and restart by the engine automatic stop and restart apparatus according to the first embodiment of the present invention. FIG. 12 illustrates the same case as that of FIG. 11. Specifically, the engine automatic stop is implemented in the vehicle running state. Then, when the restart conditions are satisfied based on the operation performed by the driver while the engine is rotating by inertia, the fuel injection is restarted. Immediately after the start of the energization of the ignition device 22 for the purpose of the ignition of the injected fuel, the ignition switch is turned OFF to interrupt the restart.

In FIG. 12, the parts (a) to (g) are the same as those illustrated in FIG. 11. The part (h) shows a state of the energization inhibition determination flag F3, which is set to “1” when the energization inhibition determination conditions are satisfied and is cleared to “0” when the energization inhibition determination conditions are not satisfied. The part (i) shows a temporal transition of the energization state of the ignition device 22.

After the automatic stop conditions are satisfied at time t1 of FIG. 12 while the vehicle is running, the automatic stop request flag F1 shown in the part (d) and the automatic stop-state flag F2 shown in the part (e) are set to “1” to stop the fuel injection (see Steps S101 to S104 of FIG. 5).

Next, at time t2, the restart conditions are satisfied by the operation performed by the driver. The automatic stop request flag F1 shown in the part (d) is cleared to “0” to restart the fuel injection (see Steps S105 to S107 of FIG. 5).

Subsequently, at time t3, the crank angle reaches the energization start crank angle in preparation for the ignition in the cylinder into which the fuel injected at time t2 is sucked. The engine rpm at this time is smaller than the reverse-rotation occurrence determining threshold value illustrated in FIG. 8. Therefore, it is determined that the reverse rotation of the engine may occur during the energization, and hence the energization inhibition determination flag F3 is set to “1”. At this time, the energization inhibition determination flag F3 is set to “1”, and thus the energization is inhibited (see Steps S201 to S207 of FIG. 7 and Step S402 of FIG. 10).

Next, at time t4, the ignition switch 5 is turned OFF to interrupt the restart, and hence the reverse rotation occurs. However, the energization has not been started. Therefore, even when the engine 20 is stopped after rotating in the reverse direction, the ignition or the combustion which further accelerates the reverse rotation does not occur.

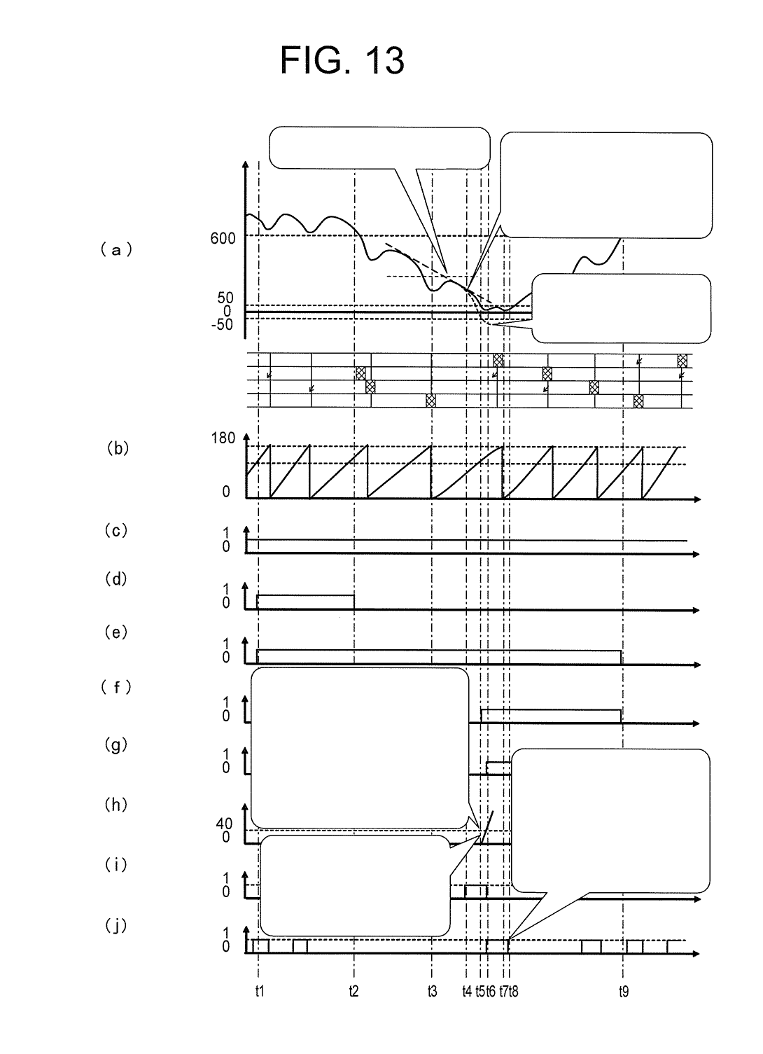

FIG. 13 is a timing chart illustrating the operation of the engine 20 relating to the automatic stop and restart by the engine automatic stop and restart apparatus according to the first embodiment of the present invention. The operation in the following case is illustrated in FIG. 13. Specifically, the engine automatic stop is implemented in the vehicle running state. When the restart conditions are satisfied based on the operation performed by the driver while the engine is rotating by inertia, the fuel injection is restarted. When the engine rpm becomes smaller than the predetermined value during the engine rotation, the pinion gear 34 and the ring gear 23 are brought into meshing engagement with each other by starting the energization of the starter 30. Thereafter, the restart of the engine 20 is implemented by cranking the starter motor 33.

In FIG. 13, the parts (a) to (g) are the same as those illustrated in FIG. 12. The part (h) shows a temporal transition of the energization time STon of the starter 30. The part (i) shows the state of the energization inhibition determination flag F3, which is set to “1” when the energization inhibition determination conditions are satisfied and is cleared to “0” when the energization inhibition determination conditions are not satisfied. The part (j) shows a temporal transition of the energization state of the ignition device 22.

After the automatic stop conditions are satisfied at time t1 of FIG. 13 while the vehicle is running, the automatic stop request flag F1 shown in the part (d) and the automatic stop-state flag F2 shown in the part (e) are set to “1” to stop the fuel injection (see Steps S101 to S104 of FIG. 5).

Next, at time t2, the restart conditions are satisfied by the operation performed by the driver. The automatic stop request flag F1 shown in the part (d) is cleared to “0” to restart the fuel injection (see Steps S105 to S107 of FIG. 5).

Subsequently, at time t3, the crank angle reaches the energization start crank angle in preparation for the ignition in the cylinder into which the fuel injected at time t2 is sucked. The engine rpm at this time is smaller than the reverse-rotation occurrence determining threshold value illustrated in FIG. 8. Therefore, it is determined that the reverse rotation of the engine may occur during the energization, and hence the energization inhibition determination flag F3 is set to “1”. At this time, the energization inhibition determination flag F3 is set to “1”, and thus the energization is inhibited (see Steps S201 to S207 of FIG. 7 and Step S402 of FIG. 10).

Next, at time t4, the engine rpm becomes smaller than the predetermined rpm at which the starter 30 can operate, and hence the energization of the starter 30 is started (see Steps S110 to S112 of FIG. 5).

Subsequently, at time t5, the energization time STon of the starter 30 becomes equal to or larger than the predetermined value (for example, 50 ms). Therefore, it is determined that the crankshaft is reliably driven in the direction of forward rotation to start the engine, and thus the energization inhibition determination flag F3 is cleared to “0”. At this time, the energization inhibition determination flag F3 is cleared to “0” and the crank angle becomes equal to or larger than the energization start crank angle. Therefore, the energization of the ignition device 22 is started (see Steps S301 to S303 of FIG. 9).

Here, whether or not to clear the energization inhibition determination flag F3 is determined based on time from the start of energization of the starter 30 as a condition for reliable forward rotation of the engine 20 after the determination of occurrence of reverse rotation. However, the condition for determining whether or not to clear the energization inhibition determination flag F3 is not limited thereto. The energization inhibition determination flag F3 may be cleared based on the detection of forward rotation by the crank-angle sensor 1 after the driving of the starter 30 is started.

Moreover, even when the crank angle passes through the TDC without the occurrence of the reverse rotation after it is determined to inhibit the energization, the crankshaft rotates in the forward direction. Therefore, the energization inhibition determination flag F3 is temporarily cleared to “0”. Then, the energization inhibition determination may be implemented again based on the engine rpm at the crank angle at which the energization of the ignition device 22 is to be started and the reverse-rotation occurrence determining threshold value.

Next, at time t6, the crank angle reaches the angle at which the energization of the ignition device 22 is to be interrupted. However, the energization time is smaller than the predetermined value, and hence reliable ignition cannot be expected. Accordingly, the energization is not interrupted (see Step S405 of FIG. 11).

Subsequently, at time t7, the energization time becomes equal to or larger than the predetermined value. Thus, it is determined that the reliable ignition can be performed. Therefore, the energization of the ignition device 22 is interrupted to perform the ignition (see Steps S405 to S407 of FIG. 11).

Next, at time t8, the engine rpm becomes equal to or larger than the engine start completion determination rpm, 600 rpm, as a result of the combustion of the fuel, and hence the engine restart is completed. Then, the energization of the starter 30 is stopped to de-energize the starter 30 (see Steps S109 and S113 to S115 of FIG. 5).

As described above, according to the first embodiment, when the occurrence of the reverse rotation of the crankshaft before the start of energization of the ignition device is determined by the reverse-rotation determining section for determining the occurrence of the reverse rotation of the crankshaft before the occurrence of the reverse rotation based on the crank angle detected by the crank-angle sensor, the ignition control section inhibits the start of energization of the ignition device.

Thus, the occurrence of ignition which accelerates the reverse rotation of the crankshaft is prevented, and good startability can be realized.

Specifically, the engine automatic stop and restart apparatus according to the first embodiment of the present invention determines the occurrence of reverse rotation during the energization of the ignition device based on the engine rpm before the start of energization of the ignition device, and inhibits the start of energization. As a result, when the restart of the engine is interrupted in a state in which the reverse rotation is detected, the ignition during the compression stroke, which accelerates the reverse rotation, can be prevented.

Moreover, the engine automatic stop and restart apparatus according to the first embodiment of the present invention determines the occurrence of reverse rotation while the ignition device is energized based on the engine rpm before the energization of the ignition device is started. When the reverse rotation does not occur after the determination and the crank angle passes through the compression TDC once, the energization inhibition is cancelled. Thereafter, the energization is immediately started. Moreover, even when the engine apparently rotates in the forward direction by the driving of the starter, the energization is immediately started. Therefore, the inhibition of the energization is prevented from being continued. As a result, good restart of the engine can be realized.

Further, the engine automatic stop and restart apparatus according to the first embodiment of the present invention performs the ignition at time at which sufficient energization time is ensured to prevent insufficient ignition, and thereby realizing the good restart of the engine, even if the energization inhibition is cancelled after the energization of the ignition device is inhibited and if the energization time is not sufficient when the crank angle reaches the crank angle at which the ignition is to be implemented.

Note that, the embodiment of the present invention can be appropriately changed or omitted within the scope of the present invention.

What is claimed is:

1. An engine automatic stop and restart apparatus for stopping fuel injection to an engine based on satisfaction of an engine automatic stop condition to automatically stop the engine and then restarting the engine based on satisfaction of an engine restart condition, the engine automatic stop and restart apparatus comprising:
a crank-angle sensor for detecting a crank angle of a crankshaft of the engine;
a starter for cranking the crankshaft to restart the engine;
a fuel injection device for injecting a fuel into the engine;
an ignition device for igniting the injected fuel;
a reverse-rotation determining section for determining occurrence of reverse rotation of the crankshaft based on the crank angle detected by the crank-angle sensor before the occurrence of the reverse rotation; and
an ignition control section for inhibiting energization of the ignition device from being started when the occurrence of the reverse rotation of the crankshaft is determined by the reverse-rotation determining section before the start of the energization of the ignition device.

2. An engine automatic stop and restart apparatus according to claim 1, wherein the reverse-rotation determining section determines the occurrence of the reverse rotation of the crankshaft based on an engine rpm during rotation by inertia after the engine is automatically stopped and a preset determination threshold value.

3. An engine automatic stop and restart apparatus according to claim 1, wherein the ignition control section cancels the inhibition of the start of the energization of the ignition device when the crank angle detected by the crank-angle sensor passes through a predetermined crank angle.

4. An engine automatic stop and restart apparatus according to claim 2, wherein the ignition control section cancels the inhibition of the start of the energization of the ignition device when the crank angle detected by the crank-angle sensor passes through a predetermined crank angle.

5. An engine automatic stop and restart apparatus according to claim 1, wherein the ignition control section cancels the inhibition of the start of the energization of the ignition device when predetermined time elapses after start of energization of the starter.

6. An engine automatic stop and restart apparatus according to claim 2, wherein the ignition control section cancels the inhibition of the start of the energization of the ignition device when predetermined time elapses after start of energization of the starter.

7. An engine automatic stop and restart apparatus according to claim 1, wherein the ignition control section cancels the inhibition of the start of the energization of the ignition device when forward rotation of the crankshaft is detected based on the crank angle detected by the crank-angle sensor after start of energization of the starter.

8. An engine automatic stop and restart apparatus according to claim 2, wherein the ignition control section cancels the inhibition of the start of the energization of the ignition device when forward rotation of the crankshaft is detected based on the crank angle detected by the crank-angle sensor after start of energization of the starter.

9. An engine automatic stop and restart apparatus according to claim 1, wherein the ignition control section performs ignition after elapse of the predetermined time when energization time of the ignition device is shorter than predetermined time even in a case where the crank angle detected by the crank-angle sensor becomes equal to a predetermined energization start crank angle after the inhibition of the start of the energization of the ignition device is cancelled.

10. An engine automatic stop and restart apparatus according to claim 2, wherein the ignition control section performs ignition after elapse of the predetermined time when energization time of the ignition device is shorter than predetermined time even in a case where the crank angle detected by the crank-angle sensor becomes equal to a predetermined energization start crank angle after the inhibition of the start of the energization of the ignition device is cancelled.

11. A method of automatically stopping and restarting an engine, executed by an engine automatic stop and restart apparatus for stopping fuel injection to an engine based on satisfaction of an engine automatic stop condition to automatically stop the engine and then restarting the engine based on satisfaction of an engine restart condition, the method comprising:
a reverse-rotation determination step of determining occurrence of reverse rotation of a crankshaft of the engine based on a crank angle of the crankshaft before the occurrence of the reverse rotation; and
an ignition control step of inhibiting start of energization of the ignition device when the occurrence of the reverse rotation of the crankshaft is determined in the reverse-rotation determination step before the start of the energization of the ignition device for igniting a fuel injected into the engine.
